(19) United States
(12) Patent Application Publication
(10) Pub. No.: US 2005/0191604 A1
(43) Pub. Date: Sep. 1, 2005

(54) Apparatus and method for teaching dyslexic individuals

(76) Inventor: William Harrison Allen, Marietta, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/789,654

(22) Filed: Feb. 27, 2004

(51) Int. Cl. G09B 17/00

(52) U.S. Cl. 434/184

(57) ABSTRACT

An apparatus for assisting dyslexic individuals, comprising a binder made of a generally rigid material and having a first section and a second section, both sections being pivotably associated with each other by a middle hinge portion; a means for generating at least one audio sound from a set of a plurality of possible audio sounds in response to an actuating signal; and, a plurality of pages associated with the binder, each page comprising a first side and a second side, each page having a plurality of discrete regions. The regions include a first region comprising a set of printed instructions, a second region comprising a three-dimensional structural graphic image, a third region displaying a given three-dimensional word, a fourth region displaying a guide for pronouncing the word, a fifth region displaying a definition of the word, a sixth region displaying the spelling of the word, and a seventh region displaying a guide for pronouncing the word. A method is also provided using a sequence of steps using the apparatus.

### FIELD OF THE INVENTION

The present invention relates to apparatus and methods of assisting dyslexic individuals to improve their reading and comprehension abilities. More particularly, the present invention provides an interactive book having an audio speaker and button area, a plurality of printed instructions and other indicia regions, a region having a three-dimensional graphical image pertaining to a word or symbol of interest, and the word or symbol of interest displayed in one or more regions in a raised format that produces a three-dimensional effect.

### BACKGROUND OF THE INVENTION

Dyslexia is a perceptual condition that results in an abnormal or altered ability to read, speak, learn and work with written characters of any kind. Any written character, such as a letter, a number, a music note, or a trigonometry sign, is nothing more than a two-dimensional symbol. The dyslexic is primarily a three-dimensional thinker who uses the experience of his/her senses to tell him/her about the world. When reading words of any kind that are in the two-dimensional format, the dyslexic individual's senses become confused and this leads him into brain dis-integration. In this state confusion reigns and frustration builds. When dis-integrated, the dyslexic (or anyone) cannot use all the resources of his brain to resolve the conflict at hand and resorts to unconscious coping behaviors to reduce the discomfort of his frustration.

The theories about the “cause” of dyslexia are many, and most describe a break-down in the function of the brain, moreover the nervous system. The message to the public in the past has been that there is a “problem” in the function of the dyslexic's brain, perhaps a pathology, which must be overcome. The implication to parents and children has been that the “hardware” of the brain is deficient and that there is something “wrong” with their poor learners. Over the years, parents, tutors and teachers have attempted to overcome a student's inability to read and write with extra, extensive practice sessions aimed at developing phonetic skills. They used enlarged letters to aid vision, and phonetics training and rote memorization to conquer the alphabet and numbers. And still, too many children read and write poorly.

The inventor of the present invention recognized that the learning disability associated with the dyslexic's inability to read, write, do math or otherwise work with written characters most often results from the lack of a fit of the individual's Gestalt thinking style with the teaching skills he is being given to learn English, or any of the languages of the Western world. It is, most often, a brain function (“software”) problem rather than a brain damage (“hardware”) problem. When the child's locus of thinking remains primarily in the three-dimensional, multi-sensory processing (Gestalt thinking) realm typical of his early development, the locus of his thinking does not progress to the areas of linear, abstract thinking (logic thinking). His lack of ability to integrate well his Gestalt-initiated brain functions with his logic-initiated brain functions puts him at risk for developing learning disabilities. He is not suited to the linear, largely two-dimensional, logical style of teaching available in school.

In contrast to the high occurrence of dyslexia in the Western speaking world is the minimal occurrence of the dyslexia phenomenon in China. It is believed that the low occurrence of dyslexia in China is due to the nature of the Chinese language. It is a language filled with sensory experience, and each Chinese written character/word has an associated sensory experience. Since three-dimensional significance can be associated with every two-dimensional written character in Chinese (and, there are over 10,000 characters), Chinese characters “make sense” to the Chinese child.

In the English language, there are at least 290 sight words punctuation marks and abstract symbols that we use often. Some examples of sight words are: a, and, I, me, the, he, she, my, on, and the like. These words and all abstract symbols have no sensory experience associated with them. Therefore, specific techniques are required to learn to read and write them. These words and symbols gain meaning when they are associated with concrete, sensory experiences of using them, or when they are explained in already meaningful abstract terms that are associated with sensory experiences and meaning.

There are dozens of methods currently being used to address dyslexic students, such as, but not limited to, Wilson Learning, Sylvan Training, Hooked on Phonics, Orten-Gillingham, which use the tools of phonemes and/or phonetics. None of these methods teach the student how to master the three parts of an abstract word; nor do they teach the dyslexic about the utilization of the mind's eye. Yet, managing the mind's eye and mastering the three parts of an abstract word are two critical keys to correcting the learning disability associated with dyslexia.

The Church of Scientology and Davis Dyslexia Association International both teach the dyslexic three-dimensionally by the use of manipulating clay to experientially represent words and their meanings. The Church of Scientology now uses inanimate, three-dimensional, generic objects instead of clay. It still does not recognize the mind's eye or its importance in the learning process.

The Davis method, like the present invention, recognizes the importance of managing the mind's eye, and that abstract words and written symbols have to be mastered three-dimensionally. Both programs, Davis and the present invention, recognize that the mastery of a word happens when the dyslexic knows and can use all three parts of it, i.e., what the word looks like on paper, what the word sounds like, and what the word means. Unlike the present invention, the Davis method is relatively expensive, inflexible, and time intensive; it uses the sculpting of clay instead of audio-facilitated structural graphics books, and requires travel to a facility for training rather coaching over the Internet.

### SUMMARY OF THE INVENTION

The present invention provides an apparatus in the form of a book with a specifically designed and laid out organizational pattern, with selected areas being in three-dimensional relief or “pop up” type presentation, together with a sound generating board for generating the audible pronunciation of a subject word for the student to hear. In one exemplary embodiment, a book is laid out with various areas of instructions, visual presentation, pronunciation region, definition region, spelling region, sentence formation, query region, as well as other regions.

According to one exemplary embodiment of the present invention, a sequence of steps is used to programmatically progress through a given page or pages of the book to concentrate on a particular study word, phrase, sound, punctuation mark or the like.

According to one exemplary embodiment of the present invention, an apparatus for assisting dyslexic individuals is provided, comprising a binder made of a generally rigid material and having a first section and a second section, both sections being pivotably associated with each other by a middle hinge portion; means for generating at least one audio sound from a set of a plurality of possible audio sounds in response to an actuating signal; and, a plurality of pages associated with the binder, each page comprising a first side and a second side, each page having a plurality of discrete regions comprising; a first region comprising a set of printed instructions, a second region comprising a three-dimensional structural graphic image, a third region displaying a given three-dimensional word, a fourth region displaying a guide for pronouncing the word, a fifth region displaying a definition of the word, a sixth region displaying the spelling of the word, and a seventh region displaying a guide for pronouncing the word.

Other features and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the figures of which:

FIG. 1 is a schematic view of one exemplary embodiment of an apparatus of the present invention with the book shown in a closed position.

FIG. 1A is a perspective view of one exemplary embodiment of an apparatus of the present invention with the book shown in an open position

FIG. 2 is a schematic view of one exemplary set of sight word pages of the embodiment of FIG. 1.

FIG. 3A is a schematic view of one exemplary set of lower case alphabet pages of the embodiment of FIG. 1.

FIG. 3B is a schematic view of one exemplary set of upper case alphabet pages.

FIG. 4 is a schematic view of one set of exemplary punctuation pages of the embodiment of FIG. 1.

FIG. 5 is a flow diagram of the sound board component of the embodiment of FIG. 1.

FIG. 6 is a schematic diagram of the sound generator circuitry of FIG. 5.

FIGS. 7A & 7B are flow diagrams illustrating one exemplary embodiment of a sight word method according to the present invention.

FIG. 8 is a flow diagram illustrating one exemplary embodiment of an alphabet method according to the present invention

FIGS. 9A-9C are flow diagrams illustrating one exemplary embodiment of a punctuation method according to the present invention.

FIG. 10 is a schematic view of a back cover of an exemplary embodiment of the present invention.

### DETAILED DESCRIPTION OF THE EMBODIMENTS

Apparatus

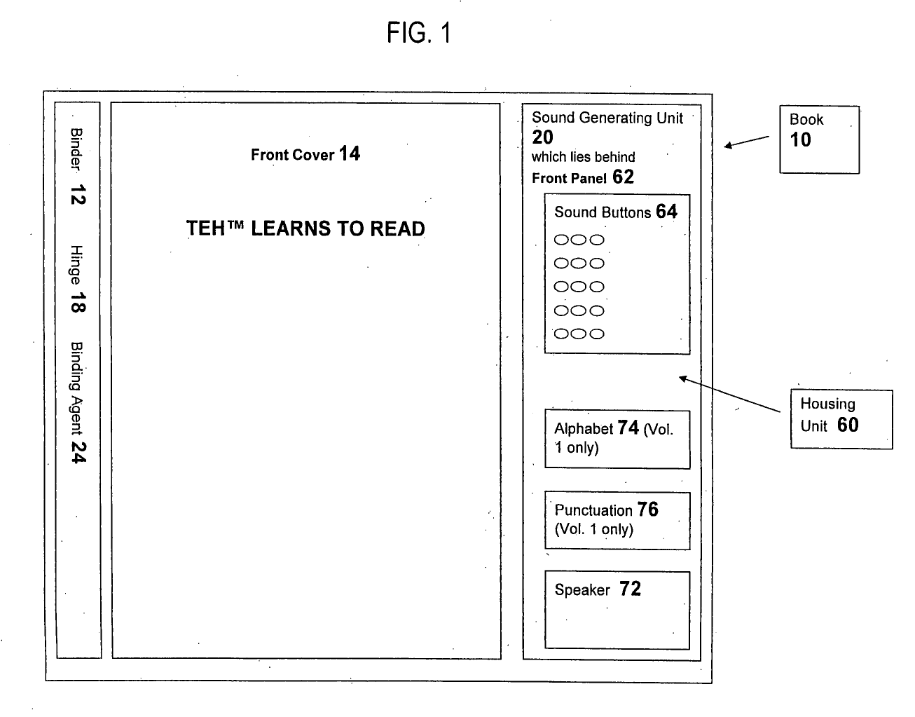

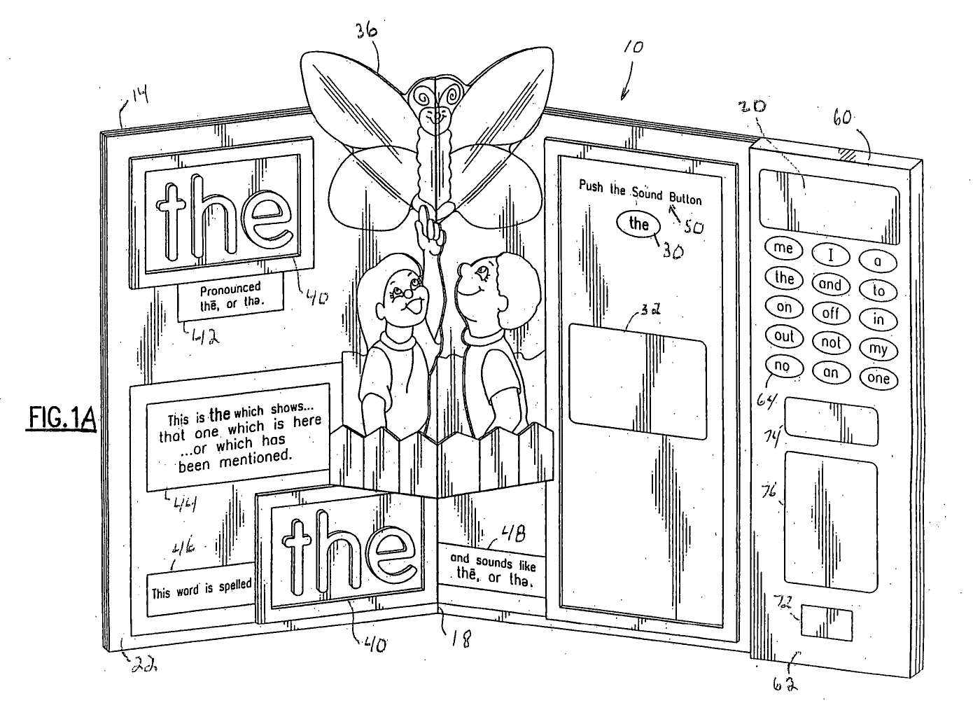

The present invention provides an apparatus for assisting in teaching dyslexic individuals. FIG. 1 and 1A show one exemplary embodiment having a book 10 generally comprising a binder 12 having a front cover 14, a back cover 16 (not shown in FIG. 1), and a hinge portion 18. A sound generating unit 20 within a housing 60 is associated with the back cover 16.

The binder 12 is preferably constructed of a generally rigid material, such as cardboard, pressboard, wood, plastic, composite, combinations of the foregoing or the like or other materials known to those of ordinary skill in the art. While flexible material may also be used, a more rigid material is preferable to maintain the book 10 in a stable position during use.

At least one and preferably a plurality of alphabet pages 19 and 21, sight word page 22 and/or punctuation page 23 are associated with the binder 12, preferably at the generally vertical midsection of each page by a binding agent 24, such as, but not limited to, stitching, stapling, gluing, hinges, combinations thereof or the like or other materials or techniques known to those of ordinary skill in the art.

Alternatively, the book can be designed as a spiral-bound book or a ring bound book, as are known in the art. Each sight word page 22 comprises a first section 26 and a second section 28, which may occasionally be referred to herein as the left side and right side of the page, respectively. Alphabet pages 19 and 21 also comprise a first section 26 and a second section 28 connected by the binding agent 24. The page 23 preferably, though not mandatorily does not extend across the binding agent 24. Each punctuation page 23 comprises a single page, ending at the binding agent 24 of the book 10. The pages 19, 21, 22 and 23 are preferably made of paper, but can also be made of plastic, fiberboard, cardboard, oak tag, combinations thereof or other material known to those skilled in the art.

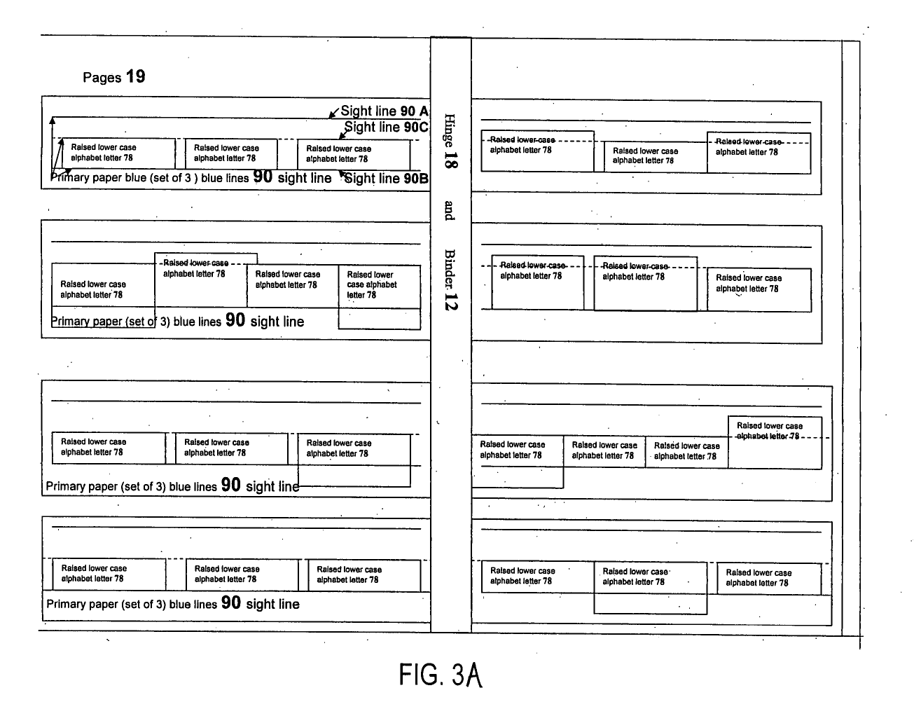

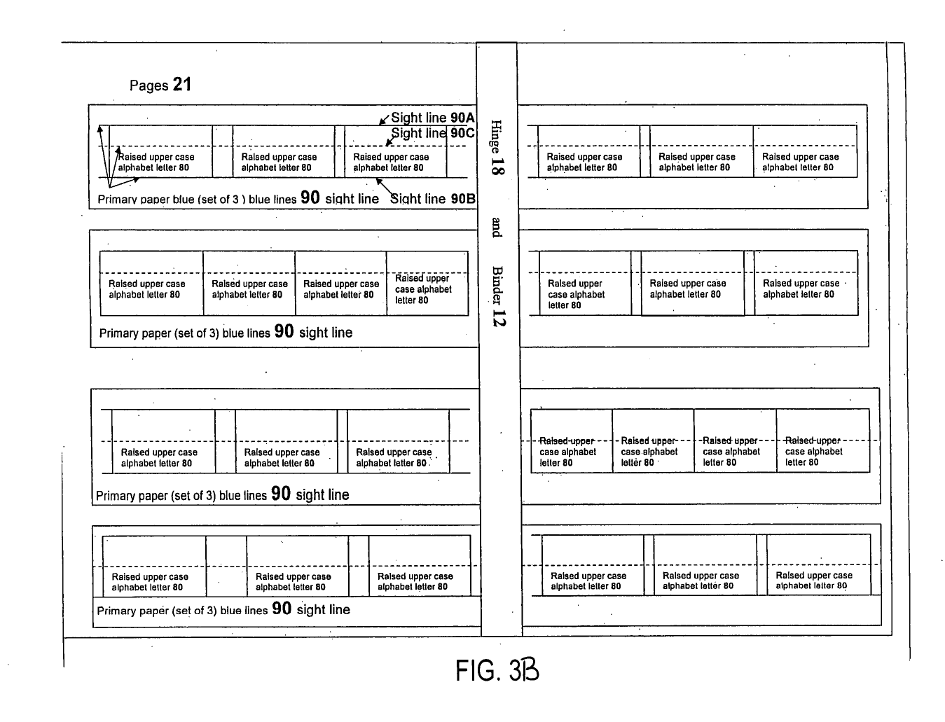

One exemplary lower case alphabet page 19 (shown in FIG. 3A has twenty-six (or other number of) raised lower case alphabet letter 78 ordered from “z” to “a” of lower case letters, and another exemplary upper case alphabet page 21 (shown in FIG. 3B) has twenty-six (or other number of) raised upper case alphabet letters 80 ordered from “Z” to “A” of upper case letters. All raised alphabet letters 78 or 80 are preferably arranged along the sight or alignment lines 90 to show their correct shape and position on the printed line. The sight lines 90 preferably include a set of three parallel lines. Lines 90A and B are preferably solid (although dashed, dotted, colored or other visual markings can be used) and are above and/or below, respectively, the top and bottom portions of the letter (with letters such as “g”, “h”, “j”, etc., possibly going above or below the line). Line 90C is preferably dashed or dotted and is generally midway between lines 90A and B. It is to be understood that a different number of sight lines 90 may be used; e.g., for different languages or symbol sets.

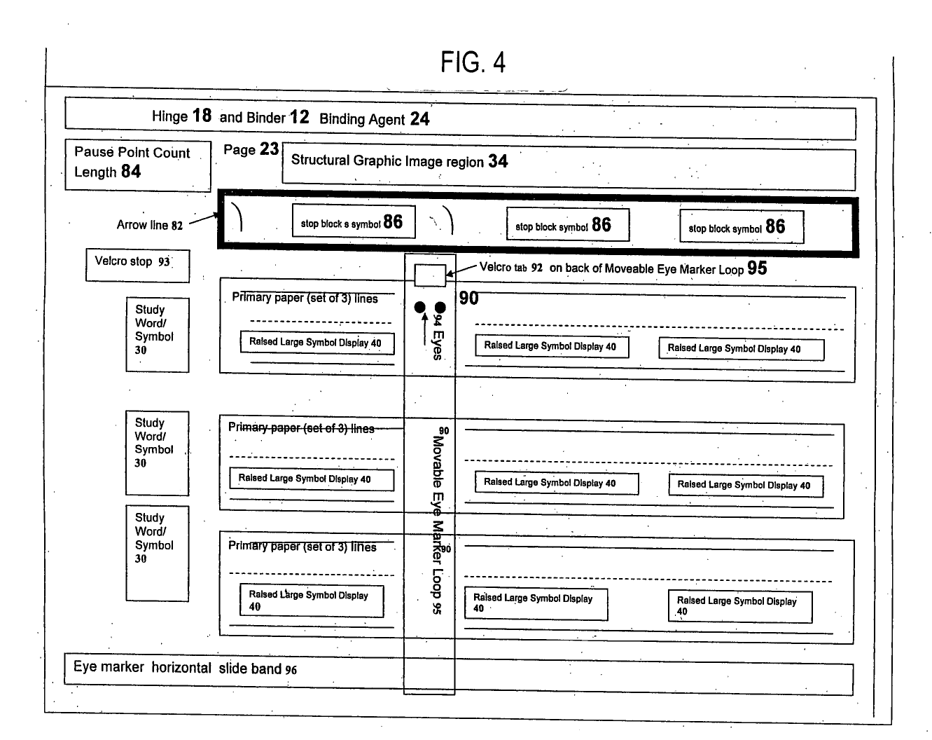

As shown in FIG. 4, each punctuation page 23 has discrete regions containing particular aspects of punctuation marks and their rhythmic use as pause points. Structural graphic image region 34 provides three-dimensional symbols that represent the rhythm of pauses at the punctuation pause points. Raised punctuation marks 88 are arranged along the sight lines 90 for three-dimensional pause point rhythm recognition and practice. The related name and symbol of each punctuation word/symbol 87, are found at preferably the left margin of sight line 90 on the page 23 and are related to the raised punctuation marks 88 along the sight line 90. Each page 23 has punctuation word/symbol 87 and related, repeated raised punctuation marks 88, pause point count length regions 84 that describe the count or rhythm of the pause point, repeated raised stop block symbols 86 that three-dimensionally represent the rhythm of the pause points, a movable eye marker loop 95, preferably with two eyes 94 at the top of the movable eye marker loop 95, slides along an eye marker horizontal slide band 96 that can be attached by a repositionable (e.g., hook and loop, repositionable, or the like) tab 92 on the back of the movable eye marker loop 95 to the (repositionable adhesive) stop 93 at the left side of the page 23, and that can be moved vertically and horizontally by the student S along a line of raised punctuation marks 88 to simulate three-dimensional eye movement along a line of print between the stop block symbols 86 of the pause points.

Each sight word page 22 has a set of discrete regions containing particular aspects of the visual, tactile, auditory and verbal teaching method. The various regions will now be described in brief. The functionality of each region will be described in greater detail hereinbelow in the operating section. Each sight word page 22 has a particular study word 30 of interest for study. It is to be understood that that the study word 30 may be in English or any other language, or may be a word fragment (e.g., prefix, suffix or the like).

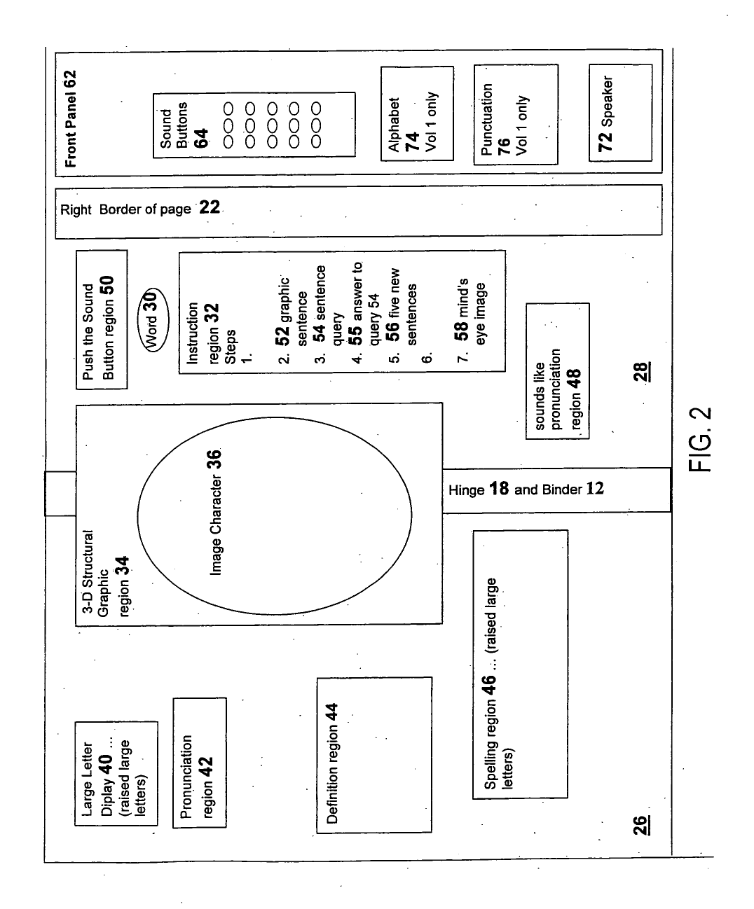

As shown in FIG. 2, starting at the top of the second section 28 of the (right side of) sight word page 22, initial instructions (e.g., “push the sound button”) are found in region 50. Below region 50 is a visual representation of the study word 30 for that page.

The instruction region 32 (see FIG. 2) contains a visual representation in the form of letters of the study word 30 for the page. The instruction region 32 also contains a set of printed instructions, which separately include a number of steps (shown in FIG. 2 in an exemplary embodiment as seven steps, it being understood that seven greater or different steps can be used), for the instructor to use as a guide for using the present invention. The following steps are exemplary and not by way of limitation. Step # 2 contains the graphic sentence 52 which describes the action of the three-dimensional structural graphic region 34. Step #3 contains a query 54 of the use of the definition 44 by the graphic sentence. Step #4 contains the answer 55 to the query 54. Step #5 contains the five (or other number of) new sentences 56 that the student creates to use the study word 30 in accordance with the definition of the word as shown in definition region 44. Step 7 contains the mind's eye image 58 that shows the height, width and depth of the letter(s) of the study word 30 as spelled in spelling region 46 that is created by the student S. The “mind's eye” is the student's brain's imaging of a remembered image or scene, such as but not limited to, after the image has been removed from the visual field of the student.

A preferably structural graphic image region 34 is a three dimensional image of a picture depicting a referred to sentence 54. The three-dimensionality is preferably achieved by utilizing a conventional “pop up” device of paper (or other material) as is known in the art that has been designed, cut, attached in part to the page 22 and folded such that when the page 22 is opened the pop up device extends out of the plane of the page to form a three-dimensional picture. The structural graphic image 34 is designed specifically to correlate to the definition of the study word 30. Alternatively, the three-dimensional image can be created by holographic or other technique, or may incorporate a computer and electro-optic (e.g., liquid crystal) display showing a three-dimensional image on a screen. It is to be understood that other ways of rendering three-dimensional images know to those or hereafter developed may be used.

A raised word display region 40 contains the study word 30 in large, raised letters. The letters of the raised large letter display 40 are raised from the page 22 to create a three-dimensional effect, which is believed to assist the student in seeing and thinking with the study word 30 in a more three-dimensional manner.

A pronunciation region 42 contains instructions on how to pronounce the study word 30, such as, but not limited to, using conventional pronunciation guides for English or other languages (it being understood that the present invention may be in the technique of English or other language or symbol sets).

A definition region 44 contains text indicating one or more definitions of the study word 30. As the study word 30 is an abstract word or symbol not generally associated with an image, the definitions are created to orient the student to experiencing the study word 30 with his/her senses.

A spelling region 46 contains a raised large letter display 40 of the letters of the study word 30. The letters of raised letter displays 40 are mandatorily raised from the page 22 to create a three-dimensional effect to enhance learning to spell the study word 30.

The sounds like pronunciation guide 48 repeats the pronunciations(s) of the study word 30 for reinforcement of all of the pronunciations of the study word 30.

While the placement and arrangement of each region on the page is not absolutely critical, it has been found that the general layout and arrangement of the regions as shown in FIGS. 2, 3 and 4 provide a visual progression through a given lesson of study to be advantageous to the student. The layout in FIG. 2 first provides the student with what the study word 30 looks like by way of the three-dimensional sense of touch of the raised letters in the large letter display 40. The three-dimensional sense of sound of the study word 30 is provided by pushing a sound button 64 and listening to a recorded (or computer or otherwise generated) voice that pronounces the word in all given pronunciations. These pronunciation(s) are found in regions 42 and 48. What the study word 30 means is given verbally in the definition region 44, and is three-dimensionally demonstrated by way of the structural graphic image 34. The spelling of the study word 30 is given in raised letters in spelling region 46, and is voiced, one letter at a time, when the button 64 is pushed for the study word 30. What the word sounds like 48 again reproduces each given pronunciation of the study word 30 in order to reinforce the number of ways in which the study word 30 can be said. Finally, the instruction steps in instruction region 32 guide the Teacher T and Student S sequentially through the process of using the information on page 22 of a study word 30.

The sound generating unit 20 is of a design commonly known to those skilled in the art and available in many children's books preferably comprises (as shown in FIG. 1) a housing 60, which may be made of plastic, cardboard, polymer, composite, combinations of the foregoing, or other materials known to those of ordinary skill in the art. The housing 60 is associated with the back cover 16 material by glue, rivets, screws, grommets or other fastening means known to those of ordinary skill in the art. A front panel 62 comprises a plurality of input interfaces, which may be buttons 64 actuatable by the user. Inside the housing 60 may be a circuit board 61 comprising the user interface, a battery 66 or other power source (e.g., alternating current, solar cell, or the like), memory storage unit 68, tone generator 70 and a speaker 72.

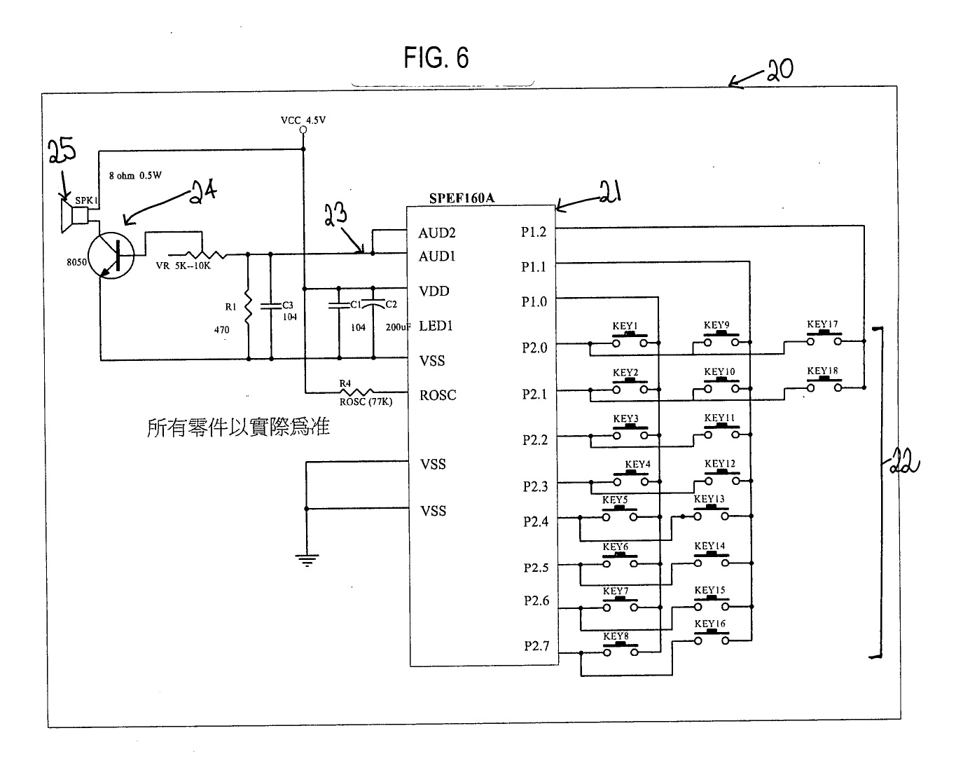

A more detailed discussion of the sound generating the 20 (see FIG. 6) follows. The sound generating unit 20 converts a physical stimulus into an audible sound. The sound generating unit 20 has a sound controller 20A connected to a plurality of momentary switches or push-button keys 64. The push-button keys 64 are connected to the input/output ports P2.0 to P2.7 of the sound controller 20A. The audio output 20B of the sound controller 20A is connected to an adjustable amplifier 20C which is connected to a speaker 72. A typical sound generating unit 20 is available from Sunplus Technology under the part number SPEF160A.

In operation, a physical stimulus is received on at least one of the push-button keys 64. The sound generating unit 20 converts the physical stimulus or digital input into an analog signal and applies that signal to the adjustable amplifier 20C. The adjustable amplifier 20C may, if desired, be adjusted to any convenient sound level via speaker 75 suitable for the present invention 10. The user may, if desired, make contact or depress a series of push-button keys 64 in a predetermined sequence to generate tones that represent or form words of any selected language.

Sight Word Method

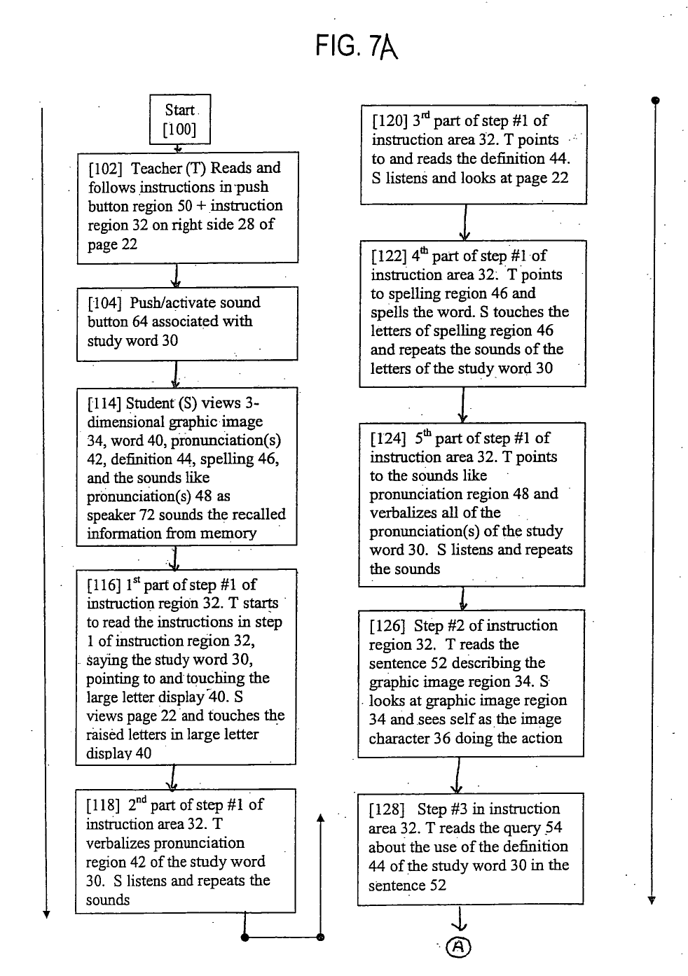

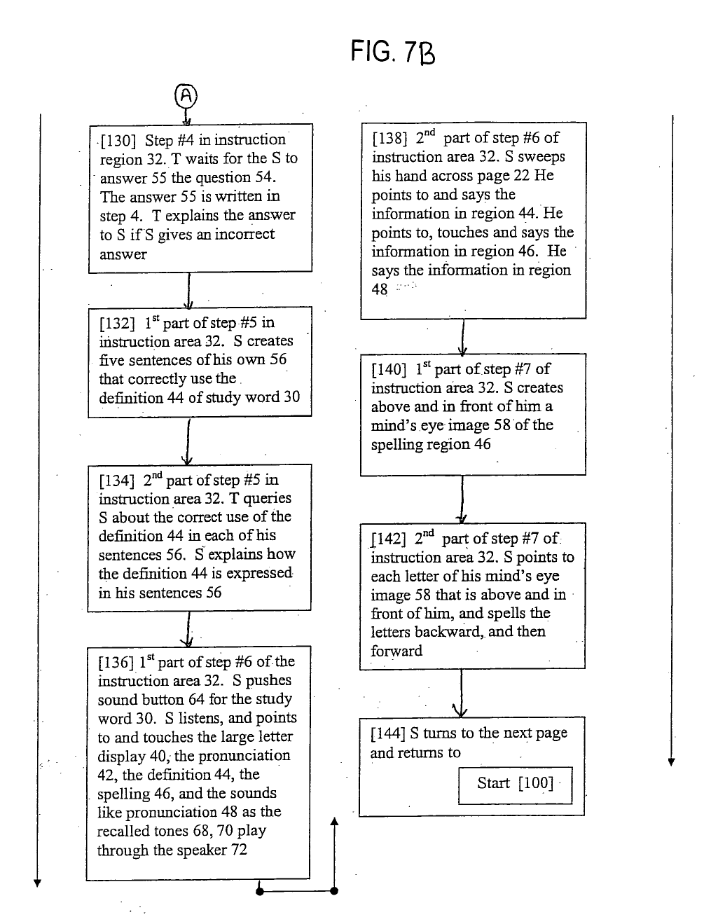

The present invention also provides a method for teaching dyslexic individuals how to better read and comprehend language. According to one exemplary sight word method of the present invention, a sequence of interactive instructor and student steps are followed. FIGS. 7A & 7B show a flow diagram of one exemplary set of steps for learning sight words. It is to be understood that variations or modifications to this sequence are possible and are included as being within the scope of the present invention.

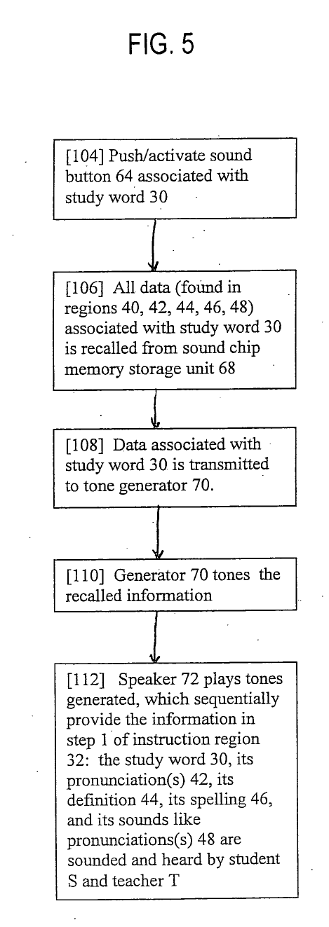

Initially, when a student opens the book, the study word 30 (which may alternatively be an abstract word, phrase, an alphabet letter, a symbol, a punctuation mark, a phoneme, a syllable, a prefix, suffix, sound or the like) is shown above the instruction region 32. The student may then search for the study word 30 on the front panel 62 of the housing 60 and press the appropriate button 64 for the study word 30. As shown in FIG. 5, the word sound(s) is/are retrieved from the memory storage device 68 and a signal is sent to the tone generator 70, which plays the tone through the speaker 72 so that the student can hear the study word 30 pronounced (see the pronunciation region 42) correctly in all ways it is spoken, the definition 44 given for the study word 30, the spelling 46 of the word, and the pronunciation repetition in the sounds like pronunciation(s) 48 of the word.

Each study word 30 is preferably presented in several regions on two pages, forming page 22, to stimulate the three-dimensional senses of sight, sound, touch and interactive experience (kinesthetics) in order to promote learning and understanding of the word. The student looks at the two sides of page 22 of a study word 30 and uses as many of his/her senses as possible to experience everything that she/he sees. Then, the Teacher T and Student S follow the directions of the numbered steps in the instruction area 32 on the right hand side 28 of page 22.

Turning to FIGS. 7A & 7B of according to one exemplary embodiment of a sight word method according to the present invention, the teacher T and student S begin at the Start (block 100). The Teacher T reads the instructions in the push button region 50 and the instruction region 32 (block 102). The Teacher T or the Student S activates the word sound button 64 (block 104) for the study word 30. The Student S and Teacher T listen to and read along while the voice comes from activating the sound button 64 with the recalled information from the memory storage unit 68.

Turn to FIG. 5 for a more detailed description of the sound generation aspect of the method. After the sound button 64 is activated (block 104), the study word 30 is retrieved from memory storage unit 68 (block 106). Tone data is transmitted to the tone generator 70 (block 108), which generates the tones of the recalled information (block 110) and plays this data through the speaker 72 (block 112).

Turning to FIGS. 7A & 7B, the Student S and Teacher T view and touch the three-dimensional representation of the raised large letter display 40 of the study word 30. They view the structural graphic image 34 related to the study word 30, the pronunciation(s) region 42, the definition region 44, the raised letters of the spelling region 46, the pronunciation repetition in the sounds like pronunciation region 48 as they listen to the recalled information relative to the study word 30 playing through the speaker (block 114).

The teacher T reads the instructions in step #1 of the instruction region 32 for the study word 30 as the student S listens, views page 22 and touches the raised letters in the large letter display 40 (block 116).

After the teacher T pronounces the study word 30 in all ways given, the student repeats the same sounds (block 118). As the teacher points to and reads the definition in the definition region 44, the student listens and looks at page 22 (block 120). The teacher T points to the raised letters in spelling region 46 and spells the letters of the word. The student S touches the raised letters of the spelling region 46 and repeats the sounds of the letters of the study word 30 (block 122). Finally, the teacher points to the sounds like pronunciation region 48 and again verbalizes all the pronunciation(s) of the study word 30. The student S listens and repeats the pronunciations of the study word 30 (block 124).

In step #2 of instruction region 32, the teacher T reads the sentence 52 that describes the action of the image character 36 in the graphic image region 34. The student S looks at the graphic image region 34 and identifies him/herself as the image character 36 doing the action in the structural graphic image region 34 (block 126).

In step #3 of instruction region 32, the teacher T reads the sentence query 54 which asks the student S if the graphic sentence 52 shows the definition 44 of the study word 30 (block 128). In step #4 of instruction region 32, the teacher T waits for the student S to give the answer 55 to the sentence query 54. The complete correct answer to the sentence query 55 is written in step #4. If the student S gives an incorrect answer, the teacher explains the correct answer to the student S (block 130).

In step #5 of instruction region 32, the student creates five (or other number) of his/her own sentences 56 that correctly use the study word 30 and its given definition 44 (block 132). The teacher T queries the student S about each sentence 56 s/he creates and whether it shows the meaning given in the definition 44. The student S explains how the definition 44 is expressed in his/her sentences 56 (block 134). Any sentences that do not correctly use the definition 44 of the study word 30 are thrown out, and more sentences 56 are created by the student S.

In step #6 of instruction region 32, the student S pushes the sound button 64 for the study word 30. The student listens, points to and touches the large letter display 40, the pronunciation region 42, the definition region 44, the spelling region 46, and the sounds like pronunciation region 48 as the recalled tones 68 and 70 play through the speaker 72 (block 136).

The student then sweeps his/her hand across page 22 and says, “This is [insert study word 30].” S/he points to and says the definition in region 44, points to and touches the raised letters in the spelling region 46 as s/he spells out loud the letters of the study word 30, and verbalizes the pronunciation(s) in the sounds like pronunciation region 48 as s/he says the study word 30 in all ways given (block 138).

In step #7 of instruction region 32, the student S views and makes a mental picture of the raised letters in spelling region 46, and uses his/her mind's eye to create a mind's eye image 58 of these letters. The student S then turns away from the book 10 and projects his/her mind's eye image 58 in front and above him/her in the air (block 140). As each letter appears as a mind's eye image 58 in the air, s/he points to each letter and spells the letters, backward and then forward (block 142).

The student S turns the page 22 (block 144) and returns to the Start (block 100) of this FIG. 7 exemplary embodiment of a sight word method to learn the next study word 30, which is on the next page 22.

Alphabet Method

FIG. 3A provides a schematic of one exemplary set of steps for each of the two lower case alphabet pages 19 and FIG. 3B provides a schematic of one exemplary set of steps for each of the two upper case alphabet pages 21 used by the student S to learn the letters of the alphabet. The two pages 19 contain the study letters of the lower case alphabet arranged from “z” to “a” in raised lower case alphabet letter displays 78 along the sight lines 90. The two pages 21 contain the study letters of the upper case alphabet arranged from Z to A in raised upper case alphabet letter displays 80 along the sight lines 90. It is to be understood that variations or modifications to this sequence are possible.

The alphabet pages 19 and 21 span over a total of one or more pages for the lower case and for the upper case letters. The raised alphabet letter 78 or 80 are preferably arranged along the sight lines 90 in the reverse order of the alphabet, from “z” to “a”, with raised lower case letter region 78 on alphabet pages 19 and the raised upper case region 80 on pages 21 (see Figures). The letters of the raised lower case and upper case alphabet letters 78 or 80 are preferably raised from the page 19 and from the page 21 to create a three-dimensional effect, which is believed to assist the student in seeing and thinking with the study word 30 in a more three-dimensional manner.

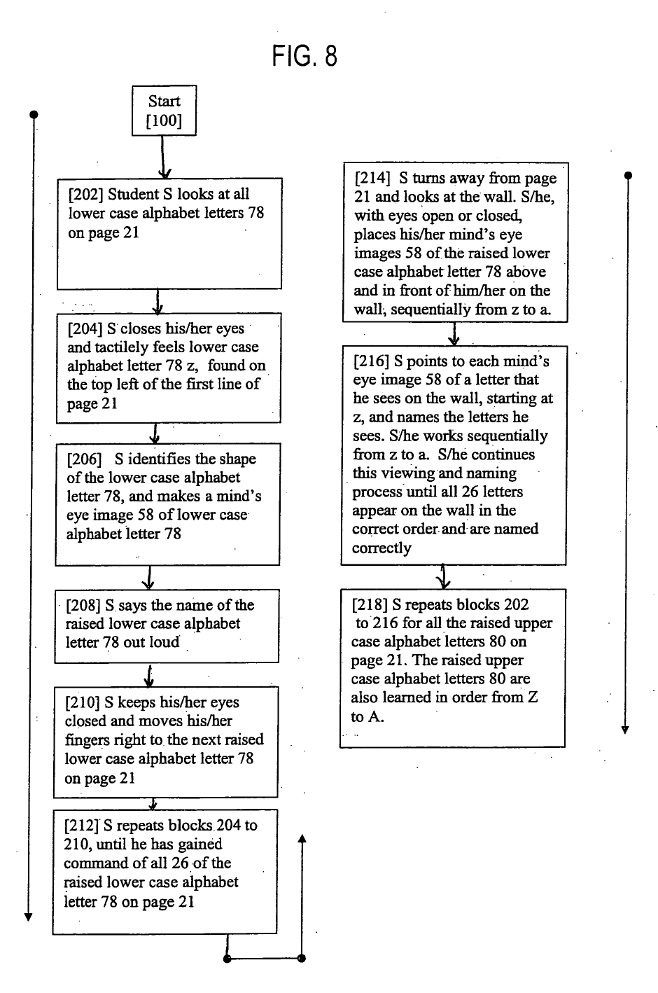

FIG. 8 shows a diagram according to one exemplary embodiment of an alphabet method according to the present invention. The student S looks at the raised lower case alphabet letters 78 of the sequentially listed alphabet letters, from “z” to “a”. The student S starts with the raised lower case alphabet letter 78 in the lower case letter region 78 (block 202).

The student S closes his/her eyes and tactilely feels the first lower case alphabet letter 78 for the lower case letter z, found at the top left of the first line of page 19 (block 204). The student S identifies the letter shape and makes a three-dimensional mind's eye image 58 of the raised lower case alphabet letter 78 (block 206). The student S states out loud the name of the raised lower case alphabet letter 78 (block 208).

Keeping his/her eyes closed, the student S moves his/her fingers to the right to the next raised lower case alphabet letter 78 on page 19 (block 210). The student S repeats blocks 204 to 210, until he has gained command of all 26 of the raised lower case alphabet letters 78 on page 19 (block 212).

The teacher T now asks the student S to turn away from book 10 and look at the wall. The teacher T asks the student S to place his/her mind's eye images 58 of the lower case raised alphabet letter 78 above and in front of him/her on the wall. The mind's eye images 58 of the letters must appear sequentially from z to a to show command of the 26 lower case alphabet letters (block 214).

The student points to each mind's eye image 58 as it appears on the wall and says the name of the letter it represents, sequentially from z to a. Any alphabet letters that are spoken in error or out of order are to be studied again (blocks 202 to 210) until the 26 lower case letters can be seen and named in order from z to a (block 216).

Once the alphabet can be said sequentially from z to a without touching the raised lower case alphabet letters 78, the student S is ready to learn the raised upper case alphabet letters 80 on page 21. Blocks 202 to 216 are repeated for each of the raised upper case alphabet letters 80 of page 21 (block 218).

Punctuation Method

FIG. 4 shows a flow diagram of one exemplary set of steps for leaming to recognize and use punctuation. It is to be understood that variations or modifications to this sequence are possible.

Each punctuation word/symbol 87 is presented over a single page 23. A preferably structural graphic image region 34 is attached to the hinge 18 and binder 12 so that the image “pops up” and is three-dimensional when the book 10 is opened to page 23. The letters of the raised large punctuation mark 88 are raised from the page 23 to create a three-dimensional effect, which is believed to assist the student in seeing and thinking with the punctuation word/symbol 87 in a more three-dimensional manner.

The three-dimensional senses of sight, touch and kinesthetics are stimulated by the structural graphic image region 34, the raised punctuation marks 88, the raised stop block symbols 86, the movable eye marker loop 95, and the rhythm of the counting that is done at each raised punctuation mark 88 and each stop block symbol 86. The sense of sound is stimulated by the voices of the teacher T and student S as they pronounce the punctuation word/symbol 87 at the left of each set of sight lines 90, and count out loud at each pause at a stop block symbol 86 and at a raised punctuation mark 88 on page 23.

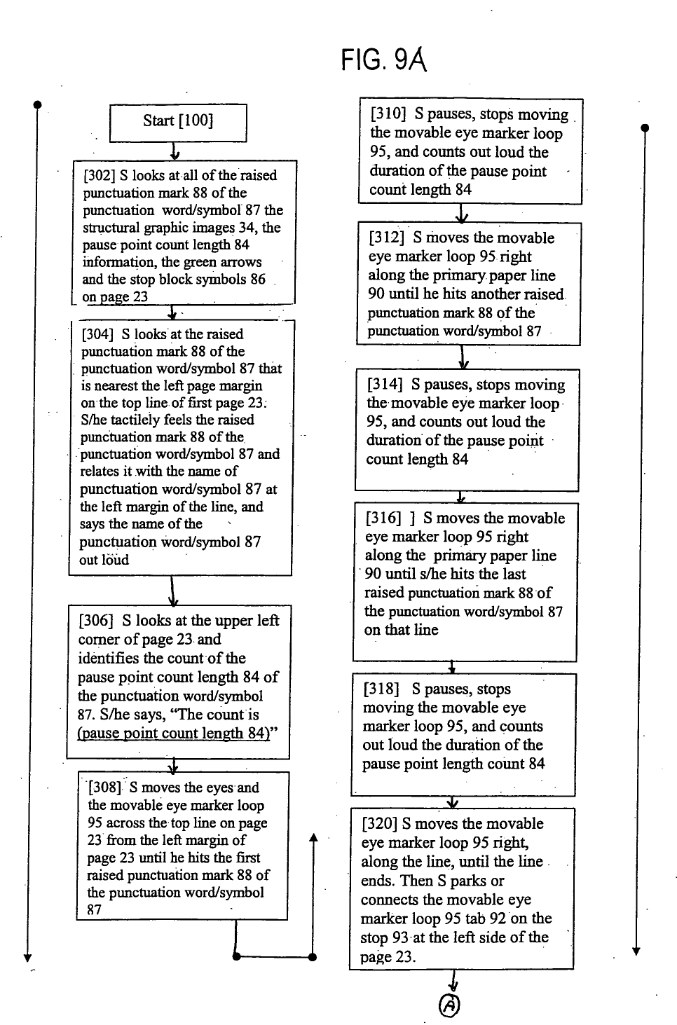

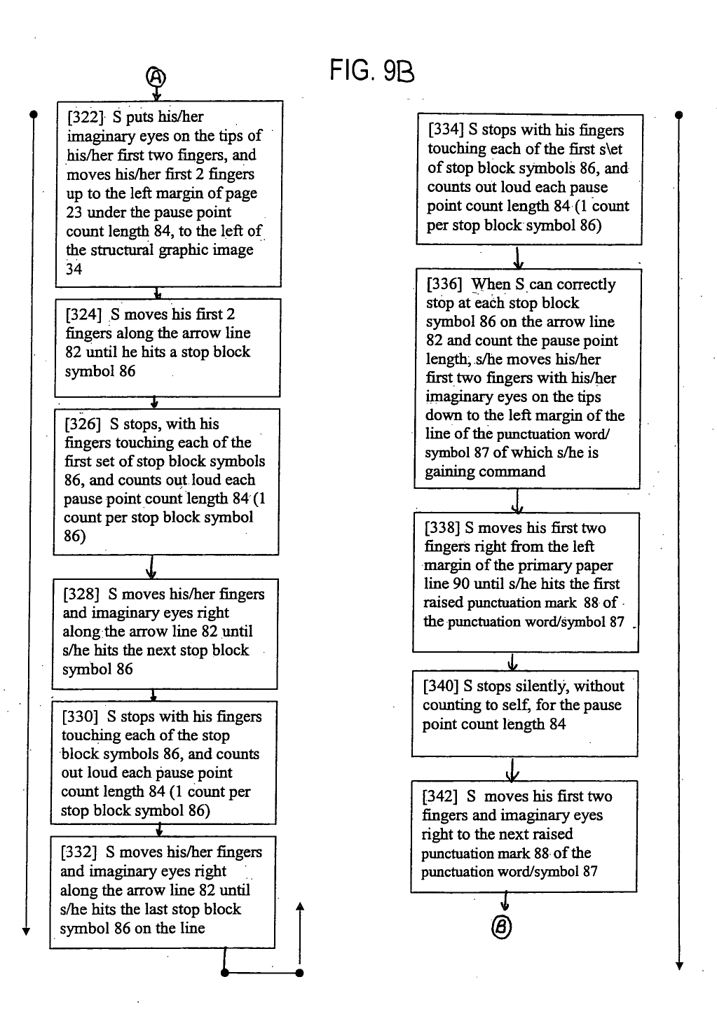

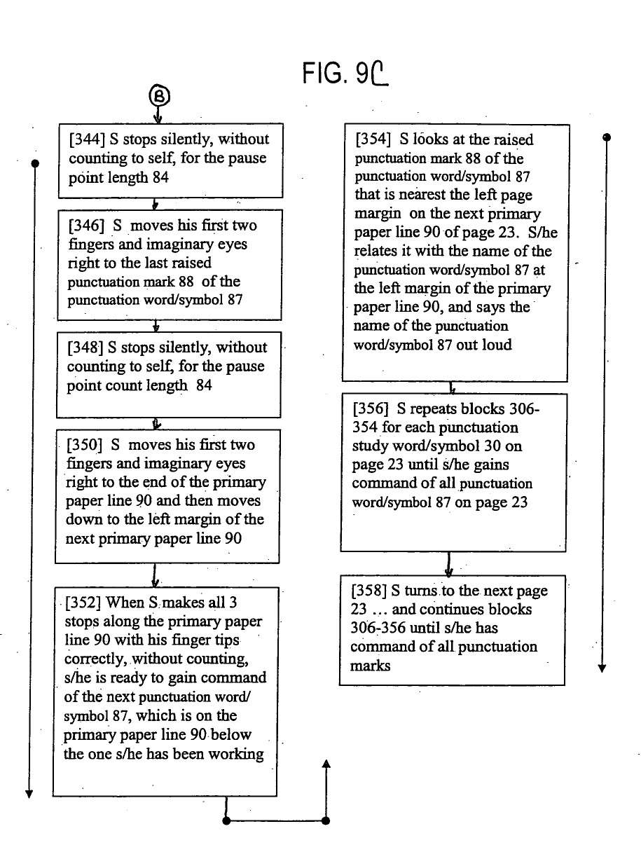

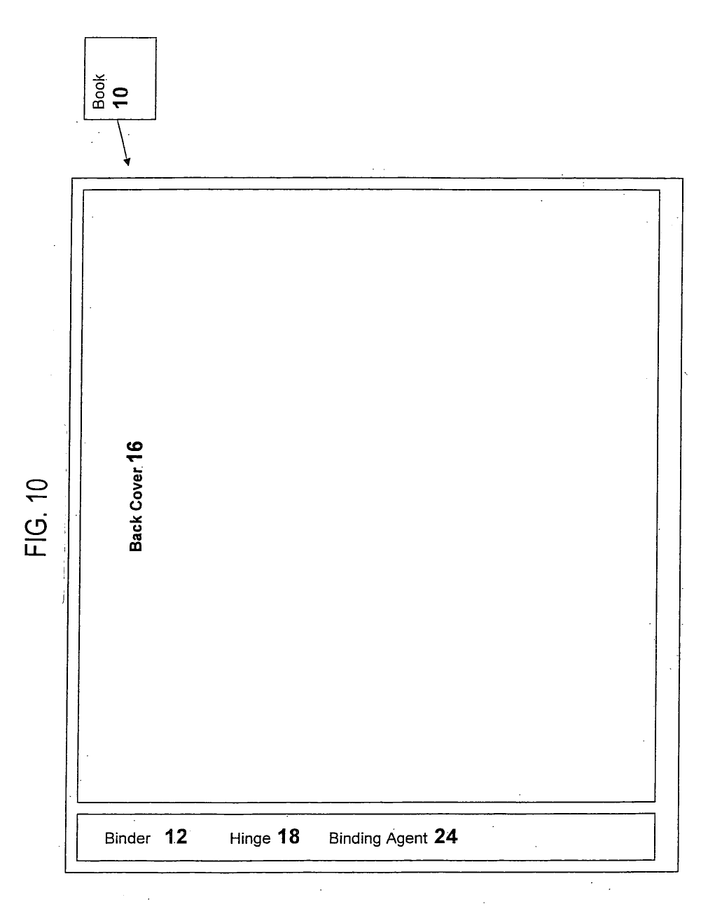

FIGS. 9A-9C shows a flow diagram of one exemplary embodiment of a punctuation method according to the present invention. It is to be understood that variations or modifications to this sequence are possible.

The student S looks at all three raised punctuation marks 88 on the sight lines 90 and at the associated punctuation word/symbol 87 located to the left of the sight lines 90. The student S looks at the structural graphic images 34 information about the rhythm of the pause used by the punctuation word/symbol 87 on page 23 and the information about the pause point count length 84. S/he looks at the raised stop block symbols 86 and the three (or other number of) arrows in the arrow line 82 which show the direction and rhythm counted for each punctuation pause point, and the movable eye marker loop 95 that can be picked up and moved horizontally and vertically along the eye marker horizontal slide band 96 so that it slides over the line of raised punctuation marks 88 until it reaches one of these punctuation marks 88 to practice the rhythm of pausing for punctuation word/symbol 87. The student S and Teacher T follow the punctuation process instructions provided at the beginning of the book 10 in the “How to Use” section (block 302).

The Student S looks at the raised punctuation mark 88 of the punctuation word/symbol 87 that is nearest the left page margin on the top sight lines 90 of page 23. S/he tactilely feels the raised large punctuation mark 88 and relates it with the punctuation word/symbol 87 at the left margin of the line, and says the name of the punctuation word/symbol 87 out loud (block 304).

The Student S looks at the upper left corner of page 23 and identifies the count of the pause point count length 84 of the punctuation word/symbol 87. S/he says, “The count is [pause point count length 84]” (block 306).

Student S picks up the movable eye marker loop 95 and moves the eyes 94 part across the set of sight lines 90 on page 23 from the left margin of page 23, until he/she reaches the first raised punctuation mark 88 of the punctuation word/symbol 87 (block 308). Student S pauses, stops moving the movable eye marker loop 95, and counts out loud the duration of the pause point count length 84 (block 310).

Student S moves the eyes 94 of the movable eye marker loop 95 right along the sight lines 90 until he/she reaches another raised punctuation mark 88 of the punctuation word/symbol 87 (block 312). Student S pauses, stops moving the movable eye marker 95, and counts out loud the duration of the pause point count length 84 (block 314).

Student S moves the movable eye marker 95 right along the sight lines 90 until he/she reaches the last raised punctuation mark 88 of the punctuation word/symbol 87 (block 316). Student S pauses, stops moving the movable eye marker 95, and counts out loud the duration of the pause point count length 84 (block 318).

Student S moves the movable eye marker 95 along the sight lines 90 until the line ends. Student S moves his/her movable eye marker loop 95 down to the left end of the next sight lines 90 on page 23 and parks the tab 92 on the back of the eye marker loop 95 on the stop 93 (block 320).

Student S now puts his/her imaginary eyes on the tips of his/her first two fingers, and moves his/her first two fingers up to the left margin of page 23, under the pause point count length region 84, which is to the left of the structural graphic image region 34 (block 322).

Student S moves his/her first two fingers along the arrow line 82 until s/he reaches a stop block symbol 86 (block 324). Student S stops, with his/her fingers touching each of the first set of stop block symbols 86, and counts out loud each pause point count length 84 (one count per stop block symbol 86) (block 326).

Student S moves his/her fingers and his/her imaginary eyes right along the arrow line 82 until s/he reaches the next stop block symbol 86 (block 328). Student S stops with his/her fingers touching each of the set of stop block symbols 86, and counts out loud each pause point count length 84 (one count per stop block symbol 86) (block 330).

Student S moves his/her fingers and imaginary eyes right along the arrow line 82 until s/he reaches the last stop block symbol 86 on the line (block 332). Student stops with his/her fingers touching each of the set of stop block symbols 86, and counts out loud each pause point count length 84 (one count per stop block symbol 86) (block 334).

When the student S can correctly follow the arrow lines 82 with his/her imaginary eyes, stop at each stop block symbol 86 on the arrow line 82 near the top of page 23 and count the pause point length, s/he moves his/her first two fingers with his/her imaginary eyes on the tips down to the left margin of the line of the punctuation word/symbol 87 of which s/he is gaining command (block 336).

Student S moves his/her first two fingers right from the left margin of the sight lines 90 until s/he reaches the first raised punctuation mark 88 of the punctuation word/symbol 87 (block 338). Student S stops silently, without counting to him/herself, for the pause point count length 84 (block 340).

Student S moves his/her first two fingers and imaginary eyes right to the next raised punctuation mark 88 of the punctuation word/symbol 87 (block 342).

Student S stops silently, without counting to self, for the pause point count length 84 (block 344).

Student S moves his first two/her fingers and imaginary eyes right to the next raised punctuation mark 88 of the punctuation word/symbol 87 (block 346).

Student S stops silently, without counting to self, for the pause point count length 84 (block 348).

Student S moves his first two fingers and imaginary eyes right to the end of the sight lines 90, and then moves down to the left margin of the next sight lines 90 (block 350).

When the student S makes all three stops along the sight lines 90 with his finger tips correctly, without counting, s/he is ready to gain command of the next punctuation study word/symbol 30, which is on the sight lines 90 below the one s/he has been working (block 352). Student S looks at the raised punctuation mark 88 of the punctuation word/symbol 87 that is nearest the left page margin on the next sight lines 90 of page 23. S/he relates it with the name of the punctuation word/symbol 87 at the left margin of the sight lines 90, and says the name of the punctuation word/symbol 87 out loud (block 354).

Student S repeats blocks 306 through 354 for each punctuation word/symbol 87 on page 23 until s/he gains command of all punctuation word/symbol 87 on page 23 (block 356). Student turns to the next page 23, and continues blocks 306 through 356 to gain command of all punctuation word/symbol 87 (block 358).

Advantages

The present invention utilizes three-dimensional stimulation of sight, tactile feeling, hearing and kinesthetics (body experiences) as a learning vehicle. The invention and methods encourage the student to use as many of his/her senses as possible to promote his/her learning.

The present invention can be used to teach chemistry, music, math and other subjects. The present invention can be adapted to teach in other languages and use symbol sets other than letters.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. It should further be noted that any patents, applications and publications referred to herein are incorporated by reference in their entirety.

1. An apparatus for assisting dyslexic individuals, comprising:
a. a binder comprised of a generally rigid material and having a first section and a second section, both sections being pivotably associated with each other by a middle hinge portion;
b. means for generating at least one audio sound from a set of a plurality of possible audio sounds in response to an actuating signal; and,
c. a plurality of pages associated with said binder, each page comprising a first side and a second side, each said page having a plurality of discrete regions comprising;
i) a first region comprising a set of printed instructions,
ii) a second region comprising a three-dimensional structural graphic image,
iii) a third region displaying a given three-dimensional word,
iv) a fourth region displaying a guide for pronouncing said word,
v) a fifth region displaying a definition of said word,
vi) a sixth region displaying the spelling of said word, and
vii) a seventh region displaying a guide for pronouncing said word.

2. The apparatus of claim 1, wherein said means for generating at least one audio sound comprising a circuit having
a. at least one sound generator responsive to a signal;
b. a plurality of user input interfaces each interface corresponding to a distinct sound or word, each said interface being in electrical communication with said sound generator;
c. means for powering said sound generator and said button;
d. memory storage means for storing at least one sound or word.

3. The apparatus of claim 2, wherein said means for powering said sound generator comprises a battery.

4. The apparatus of claim 2, further comprising a speaker.

5. The apparatus of claim 2, wherein said input interface comprises an acuatable button.

6. The apparatus of claim 2, further comprising a housing, said housing being associated with said binder.

7. The apparatus of claim 1, wherein said word displayed in said third and sixth regions is displayed by said letters being raised in three dimensions from said page.

8. A method of teaching dyslexic individuals, comprising:
a. providing an apparatus, comprising,
i) a binder comprised of a generally rigid material and having a first section and a second section, both sections being pivotably associated with each other by a middle hinge portion;
ii) means for generating at least one audio sound from a set of a plurality of possible audio sounds in response to an actuating signal; and,
iii) a plurality of pages associated with said binder, each page comprising a first side and a second side, each said page having a plurality of discrete regions comprising;
(1) a first region comprising a set of printed instructions,
(2) a second region comprising a three-dimensional structural graphic image,
(3) a third region displaying a given three-dimensional word,
(4) a fourth region displaying a guide for pronouncing said word,
(5) a fifth region displaying a definition of said word,
(6) a sixth region displaying the spelling of said word, and
(7) a seventh region displaying a guide for pronouncing said word;
b. displaying a particular word of interest;
c. actuating one of said plurality of buttons such that said speaker reproduces the sound of said word;
d. directing said individual to look at the three-dimensional, raised letters version of said word;
e. providing a written guide for the definition of said word;
f. directing said individual to look at said three-dimensional structural graphic image;
g. directing said individual to identify with the action of the figure in the said three-dimensional structural graphic image
h. relating said word with the action of the said three-dimensional structural graphic image;
i. providing a three-dimensional visual display of raised letters for seeing how said word is spelled
j. providing a written guide for pronouncing said word;
k. providing an example of a sentence using said word and related to said three-dimensional image;
l. directing the individual to construct at least five sentences incorporating said word and using the said definition;
m. directing the individual to construct with said individual's mind's eye an image of the raised letters of said word and projecting it above and in front of said individual's head;
n. directing said individual to point to each letter in said mind's eye image as said individual spells said word backward, and then forward;
o. providing a raised letter version of the upper and lower case alphabet;
p. providing a raise version of the punctuation symbols;
q. providing a movable eye marker; and,
r. providing three-dimensional images of pause points of different length associated with three-dimensional bumps to touch and stop eye movement left to right, illustrating the duration of pause at punctuation marks.
